(19) United States
(12) Patent Application Publication
(10) Pub. No.: US 2003/0226537 A1
(43) Pub. Date: Dec. 11, 2003

(54) Ring valve for 4-stroke piston engine

(76) Inventor: Josef Schaich, Oberreute (DE)

Correspondence Address: Josef Schaich, Schonebuhl 8, Obbereute, 88179, DE

(21) Appl. No.: 10/164,903

(22) Filed: Jun. 7, 2002

(51) Int. Cl. F02N 3/00

(52) U.S. Cl. 123/188.5

(57) ABSTRACT

The invention appertains to a gas exhaust device for 4-stroke piston engines, in the cylinder of which combustible gases and air rotate around the vertical axis of the cylinder without being mixed, and combustible gases and air escape through a gap created by a vertically movable ring valve and a stationary ring valve support seated in the cylinder.

The invention appertains to a gas exhaust device for 4-stroke piston engines, in the cylinder of which combustible gases and air rotate around the vertical axis of the cylinder without being mixed, and combustible gases and air escape through a gap created by a vertically movable ring valve and a stationary ring valve support seated in the cylinder.

### DESCRIPTION

The invention appertains to a gas exhaust device for 4-stroke piston engines as described in the U.S. Pat. citation No. 4,815,422. In such engines the rotating air stream flows through an inlet valve positioned coaxially to the vertical cylinder axis. The rotation of the air stream is created by vanes installed in the inlet channel. Fuel is injected into the spirally rotating air stream in gaseous form during the compression stroke via a nozzle which is situated a distance from the inlet valve in the compression chamber in the vicinity of the vertical cylinder axis. The injection of the fuel is carried out such that an air fuel mixture is only formed in the inner area of the cylinder and combustion chamber.

The combustion of a rotating mixture zone surrounded by a shroud of air prevents the formation of large amounts of pollutants. The relatively pollutant free exhaust gases are, however, enriched with oil in the exhaust device such that the HC content of the gases is increased.

The invention concerns itself with the issue of creating a gas outlet device in which the oscillating mass is relatively small and, in spite of good lubrication of the device, no oil is mixed with the exhaust gases. The relatively HC free combustion in the engine must be substantiated by oil free exhaust, such that the exhaust gases contain minimal amounts of non-combusted hydrocarbons. The design of the gas outlet device must further be such that its opening is not impeded by the gas pressure in the cylinder.

Gas exhaust systems are known in various types. The simple poppet valve assembly has asserted itself against the sleeve and plain slide valves. Poppet valves are, however, not suitable for use in engines in which turbulence free flow is the basic requirement for the formation of an air shrouded mixture zone with sharp edges.

Only the sleeve valve is suitable for this type of engine because the rotation-symmetrical form of the cylinder and combustion chambers are not disrupted by it.

These advantages of the sleeve valve are, however, opposed by greater disadvantages. The oscillating mass is very high and the sleeve valve opening conveys lubricating oil into the exhaust gases.

According to the invention these tasks are resolved, by a ring valve, coaxially mounted to the vertical axis of the cylinder and that part of the cylinder head that partially forms the combustion chamber. The housing of the ring valve in the cylinder is such that it can be rotated around and moved along the vertical axis of the cylinder.

The design possibilities of the ring valve are numerous and depend upon the method of ring valve activation. Common to all methods is the ring shaped part in the vicinity of the combustion chamber.

The cylindrical end of the ring valve, together with the ring valve support mounted on an annular cylinder insert, form the sealing areas. The sealing area on the ring valve and the sealing area on the stationary ring valve support can be of a concave/convex or V/wedge shape.

The ring valve and ring valve support seal off, with their sealing areas, the combustion and cylinder chamber in principle for 3 of the 4 strokes against the exhaust channel, whereby the sealing areas are at a certain distance from that part of the cylinder head which forms part of the combustion chamber.

During the exhaust stroke the ring valve is raised from the ring valve support by a suitable device, making the way clear for the exhaust gases to enter the exhaust channel, which partially surrounds the cylinder. It can be advantageous to install 2 exhaust channels at 180° to each other.

The opening and closing movement of the ring valve, dependent on certain parameters, can be controlled by a mechanical device. An electrical device, in which 2 solenoids activate the ring valve which forms the armature, is possible.

A mechanical/hydraulic device is described in detail in the following.

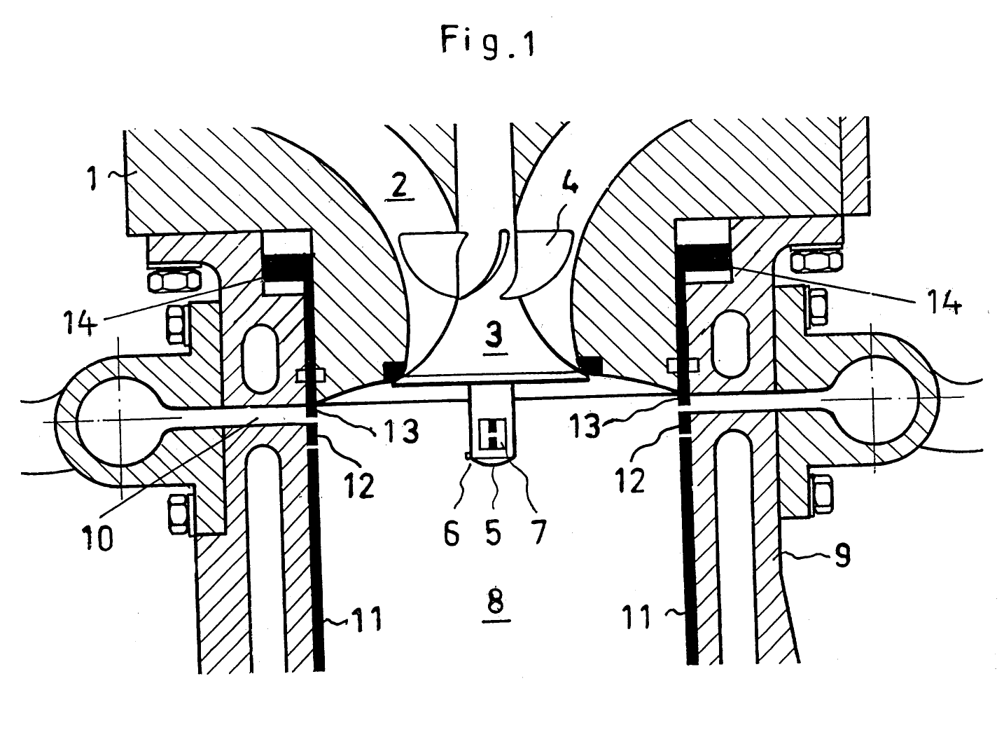

The end of the ring valve opposite the sealing area can be used as a ring shaped piston FIG. 1. Two hydraulic pumps—mainly consisting of cylinder, piston and a rotating cam activating each piston respectively—supply the piston with oil reciprocally. The frictional connection of both activating camshafts with the crankshaft of the engine, controls the ring valve in dependence of the engine strokes.

Another possibility of activating the ring valve is by using 2 tappet levers mounted at 180° and 2 valve springs to open and close the ring valve. Opening of the ring valve using this design can be done using two mechanical/hydraulic devices each consisting of a cylinder respectively in which 2 pistons are mounted, kept at a distance to each other by an amount of oil, two rotating camshafts which each activate the respective first pistons and connecting elements which transfer the force via the respective second pistons to the tappet levers. The valve springs can be replaced by 2 mechanical/hydraulic devices of the type described, whereby the oil chambers in each cylinder are connected to each other via an oil pipe for pressure compensation.

All described valve activation devices are suitable to prevent seizure of the ring valve due to canting skewing or blocking.

A seal is provided in the cylinder in order to seal the raising oil ring channel against the exhaust channel. A second seal is provided in the cylinder head to seal the closing oil ring channel against the compression chamber.

Numerous deviations of the invention are possible. Even though the exhaust temperature using the stratified charge method are relatively low it can be advantageous to insert coolant bores in the ring valve support which are connected to the cylinder cooling water.

The sealing areas of the ring valve can be cooled using oil. Blind oil holes, close to each other and bored from the ring piston up to the vicinity of the sealing areas, parallel to the axis of rotation of the ring valve not only aid cooling but also provide a reduction in weight.

The improvements achieved by the ring valve as described in comparison with conventional sleeve valves are the large reduction of the oscillating mass and the oil free exhaust gases.

FIG. 1

Position of the ring valve in the engine

1. Cylinder head

2. Air inlet channel

3. Inlet valve

4. Air vanes

5. Nozzle and electrode carrier

6. Fuel nozzle

7. Ignition device

8. Cylinder chamber

9. Cylinder

10. Exhaust outlet channel

11. Cylinder insert

12. Ring valve support

13. Ring valve

14. Ring valve piston

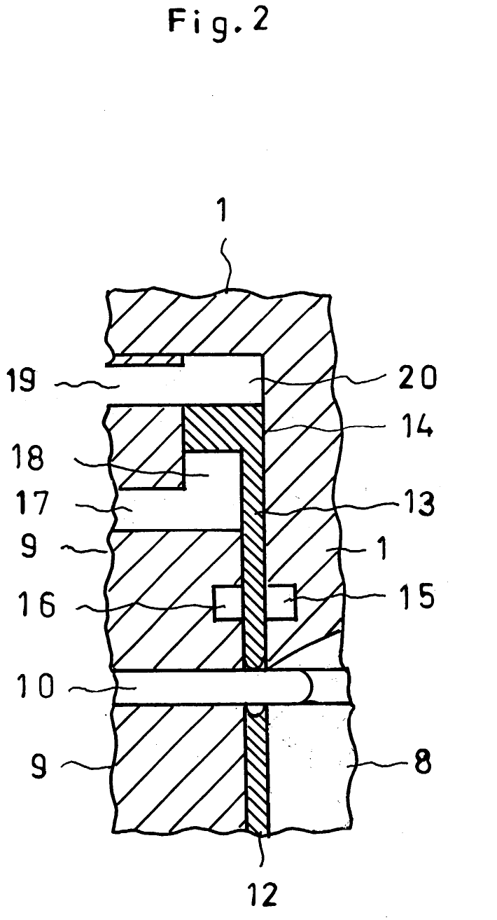

FIG. 2

Section through the ring valve

1. Cylinder head

13. Ring valve

14. Ring valve piston

15. Seal

16. Seal

17. Raising oil channel

18. Raising oil ring channel

19. Closing oil channel

20. Closing oil ring channel

9. Cylinder

10. Exhaust outlet channel

11. Ring valve support

8. Cylinder chamber

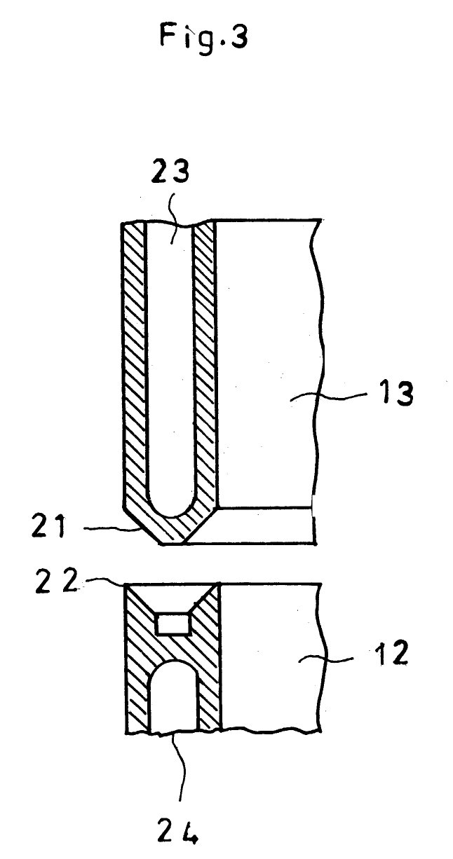

FIG. 3

Illustration of sealing areas

12. Ring valve support

13. Ring valve

21. V-shaped sealing area on ring valve

22. V-shaped sealing area on ring valve support

23. Cooling channel in ring valve

24. Cooling channel in ring valve support

1. Ring valve for 4-stroke piston engines with air intake device, fuel nozzle and ignition device characterised in that a rotating, air shrouded mixture is formed and combusted in the cylinder, during which a ring valve mounted in a cylindrical bore which is movable along the vertical axis of the cylinder and coaxially mounted to this axis, together with a ring valve support which is stationary mounted in the cylinder, seals the compression and cylinder chamber against the exhaust channel by means of sealing areas on both ring valve and ring valve support, whereby the sealing areas are situated at a distance to that part of the cylinder head which partially forms the compression chamber.
